(19) United States
(12) Patent Application Publication
(10) Pub. No.: US 2026/0298072 A1
(43) Pub. Date: Oct. 1, 2026

(54) MECHANICAL CASING DEFORMATION DETECTION TOOL

(71) Applicant: TIER 1 ENERGY SOLUTIONS, INC., Edmonton (CA)

(72) Inventors: Attila SOLYOM, Edmonton (CA); Jeffrey GOLINOWSKI, Edmonton (CA); Daniel P. LUPIEN, Edmonton (CA)

(21) Appl. No.: 19/555,418

(22) Filed: Mar. 3, 2026

Related U.S. Application Data
(60) Provisional application No. 63/778,080, filed on Mar. 26, 2025.
(60) Provisional application No. 63/901,067, filed on Oct. 17, 2025.

(51) Int. Cl. E21B 47/007; G01L 5/04

(52) U.S. Cl. CPC E21B 47/007; G01L 5/04

(57) ABSTRACT

A mechanical deformation detection tool includes a housing assembly forming part of a bottom hole assembly and cantilevered collet fingers. The tool also includes a plurality of external indicator buttons which can be displaced by radial inward movement of the collet fingers. Displacement is indicative of a deformation which deflected a collet finger, and the degree to which an indicator button is displaced is indicative of the size of the deformation. A method of detecting and localizing a deformation in a downhole tubular such as casing includes the steps of pulling the tool through the tubular while sensing and logging a pull tension indicative of friction between the tool and an inside surface of the tubular. Pull tension events can be correlated with a displacement of at least one indicator button to determine a location of the deformation.

### CROSS-REFERENCE TO RELATED APPLICATIONS

This application claims the priority benefit of U.S. Provisional Patent Application Nos. 63/778,080 filed on Mar. 26, 2025, and 63/901,067 filed on Oct. 17, 2025, the entire contents of both which are incorporated herein by reference.

### FIELD OF THE INVENTION

The present invention generally relates to a tool to detect deformations or restrictions in the internal diameter of a wellbore casing.

### BACKGROUND

It is often desirable or necessary to detect and log various defects in downhole tubulars, completion components and casings, including deformations and restrictions. Wireline caliper tools are known and used to detect and log defects. Caliper tools employ an array of fingers which measure the inner diameter of the tubular. As the caliper tool is pulled through the tubular, data is collected and processed. The resulting information may be used to make decisions regarding wellbore operations.

Downhole conditions may be very harsh, particularly in wireline plug and perf operations. Complicated and multicomponent tools may be prone to failure due to mechanical or environmental stresses. There is a need in the art for simpler and robust tools for detecting deformations or restrictions in the internal diameter of a wellbore casing.

### SUMMARY OF THE INVENTION

In one aspect, disclosed is a mechanical tubular deformation detection tool having a central longitudinal axis, comprising:
(a) a housing assembly comprising top and bottom connections to form part of a bottom hole assembly (BHA) and a collet housing defining a plurality of longitudinal slot openings;
(b) a plurality of external indicator buttons mounted in the collet housing, each moveable radially inwards from a start position;
(c) a mandrel disposed within the housing assembly, the mandrel slidingly moveable between a run-in-hole (RIH) position and a pull-out-of-hole (POOH) position; and
(c) a plurality of flexibly resilient collet fingers affixed to the mandrel and each comprising a distal end extending radially outwards through a slot opening and downwards such that the distal end is positioned over an indicator button when the mandrel is in its POOH position, wherein the distal end is radially moveable between a start position and an indicator position which bears inwardly on an indicator button.

In some embodiments, the mandrel is biased towards its RIH position with a spring. The spring can be compressed, moving the mandrel to its POOH position, by a weight forming part of the BHA.

In another aspect, disclosed is a bottom hole assembly (BHA), comprising a tool as described herein. In some embodiment, the BHA comprises at least one weight bar positioned above the tool, wherein the at least one weight bar bears upon the tool when the BHA is positioned vertically or inclined.

In another aspect, disclosed is a method of detecting a deformation in a downhole tubular, such as a casing, comprising the steps of:
(a) pulling a tool through the tubular while sensing and logging a pull tension indicative of friction between the tool and an inside surface of the tubular, wherein the tool comprises a plurality of indicator buttons, each button moveable between a start position and an inwardly depressed indicator position, wherein the button is displaced by the deformation; and
(b) retrieving the tool and determining a correlation between a pull tension event with a displacement of at least one indicator button to determine a location and size of the deformation.

In some embodiments, the tool is configured to be moveable between a RIH configuration and a POOH configuration, preferably by gravity force when the tool is moved towards a vertical orientation from a horizontal orientation.

In preferred embodiments, either the tool or the method may comprise any combination of the features, elements or steps described herein, including the omission of any optional or preferred feature, element or step.

### BRIEF DESCRIPTION OF THE FIGURES

The accompanying drawings, which are incorporated herein and form a part of the specification, illustrate some, but not the only or exclusive, examples of embodiments and/or features.

FIG. 1A shows a longitudinal cross-section of one embodiment of a mechanical deformation detection tool, in its RIH position. FIG. 1B shows a pictorial view of a portion of the tool, in its POOH position.

FIG. 2 shows a detailed portion of FIG. 1A.

FIG. 3 shows a detailed portion A of FIG. 2.

FIG. 4 shows a transverse cross-section of the embodiment of FIG. 1A.

FIG. 5 is a depiction of one embodiment of a bottom hole assembly comprising a mechanical deformation detection tool.

FIG. 6 is a schematic of a BHA in an inclined section (build section) of the wellbore and an example calculation of the forces acting on the tool at a specific angle.

### DETAILED DESCRIPTION

The present invention now will be described more fully hereinafter with reference to the accompanying drawings, in which some, but not all embodiments of the invention are exemplified. Indeed, this invention may be embodied in many different forms and should not be construed as limited to the embodiments set forth herein; rather, these embodiments are provided so that this disclosure will satisfy applicable legal requirements. Like numbers refer to like elements throughout. It is to be understood that this invention is not limited to the particular methodology and protocols described, as such may vary. It is also to be understood that the terminology used herein is for the purpose of describing particular embodiments only, and is not intended to limit the scope of the present invention.

Many modifications and other embodiments of the invention set forth herein will come to mind to one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

In describing a downhole tool or assembly, “uphole” or “proximal” is the direction towards the surface, while the “downhole” or “distal” direction is the opposite direction, towards the bottom or end of the wellbore. Conventionally, when an elongated device is shown with its main longitudinal axis shown horizontally in a drawing, the uphole end is on the left hand side. The terms “radial”, “lateral” or “transverse” are used in relation to a direction or plane which intersects the main longitudinal axis, preferably at a perpendicular angle. Directional prepositions refer to the device either as it is oriented and appears in the drawings, or with reference to the uphole and downhole directions, and are used for convenience only; they are not intended to be limiting or to imply that the device has to be used or positioned in any particular orientation, except where noted. Conventional components of the invention are elements that are well-known in the prior art and will not be discussed in detail for this disclosure.

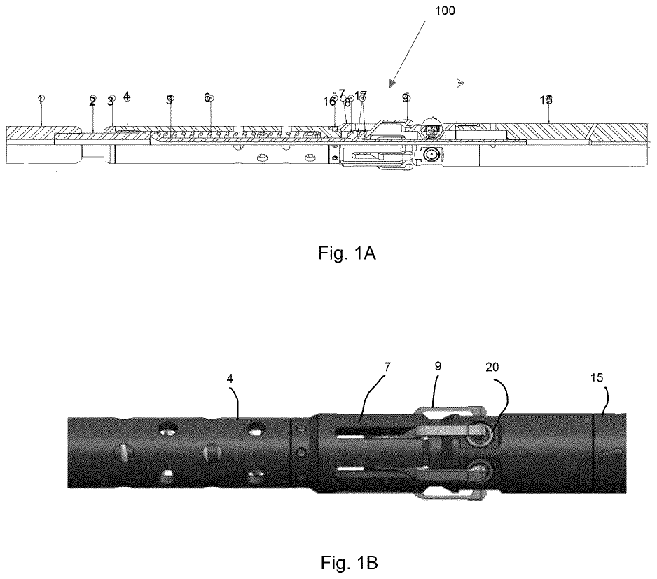

The disclosed mechanical casing deformation detection tool 100 is entirely mechanical, there are no electrical components or connections. FIG. 1A shows one embodiment of a tool 100 having a central longitudinal axis, comprising:
(a) a housing assembly comprising a top connector 1 and a bottom connector 15 to form part of a bottom hole assembly (BHA), and a collet housing 7 defining a plurality of longitudinal slot openings 16, wherein the collet housing 7 comprises a plurality of external indicator buttons 20, each moveable radially inwards from a start position;
(b) a mandrel 5 disposed within the housing assembly, the mandrel 5 slidingly moveable between a run-in-hole (RIH) position and a pull-out-of-hole (POOH) position; and
(c) a plurality of cantilevered collet fingers 9 affixed to the mandrel 5 and each comprising a distal end extending radially outwards through a slot opening 16 and downwards such that the distal end is positioned over an indicator button 20 when the mandrel is in its POOH position, wherein the distal end is transversely moveable between a start position and an indicator position which bears inwardly on an indicator button 20.

The top connector 1, a connecting rod 2, the mandrel 5 and the bottom connector 15 together form a tubular assembly through which a wireline may pass. The housing assembly is concentrically disposed around the mandrel 5 and is further comprised of an upper lock ring 3 and a spring housing 4, together with the collet housing 7. The spring housing 4 is attached to the collet housing 7 with a plurality of bolts or set screws 16. The connection may be strengthened with a threaded connection in addition to the set screws 16.

The indicator buttons 20 are mounted in a lower portion of the collet housing 7, preferably within an insert 21 that is securely threaded into the collet housing 7. Each indicator button 20 defines ratchet teeth 22 which cooperate with ratchet teeth on an inner surface of the insert 21 to permit inward travel but not outward travel. The buttons 12 are preferably biased outwards, such as with a spring 13.

A collet holder 8 is attached to the mandrel 5. A plurality of cantilevered collet fingers 9 are attached to the collet holder 8, arrayed around the circumference of the tool 100. Each collet finger 9 is firmly attached to the collet holder 8 at a proximal end with bolts 17, and protrudes through a slot opening 16 in the collet housing 7. The distal end 9a is unsupported and extends outwards and downwards. The distal end 9a comprises an outer surface and a bulbous inwards protrusion. The plurality of collet finger 9 outer surfaces collectively define an outside diameter (OD) of the tool 100, as may be seen in FIG. 4. Each collet finger 9 individually defines a radius distance R between the distal end outside surface and a central longitudinal axis of the tool, as may be seen in FIG. 4.

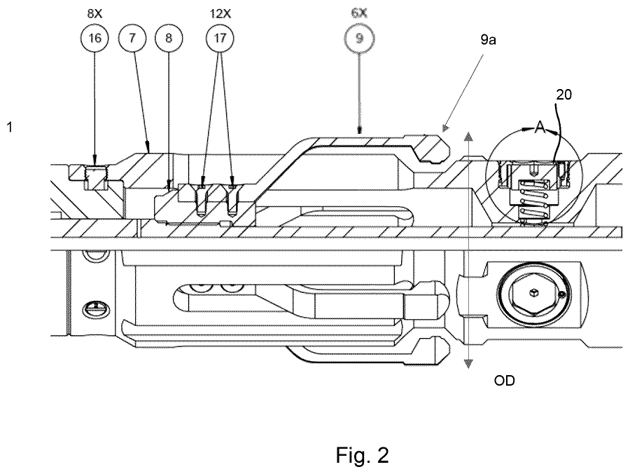

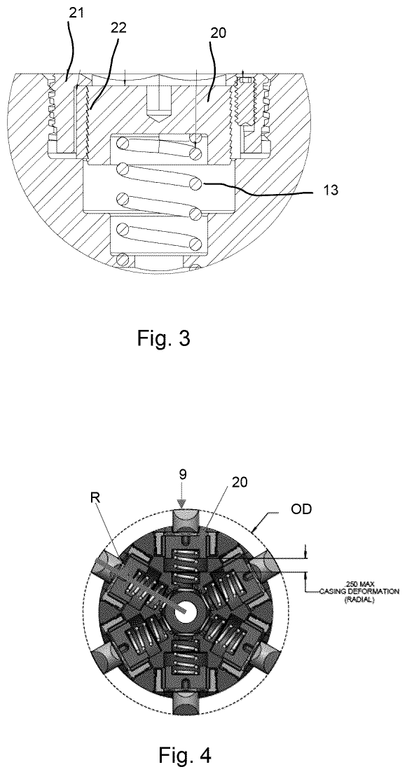

The tool 100 is biased in a running-in-hole (RIH) position, where the bulbous distal ends of the collet fingers 9 are positioned in the undercut profile defined by the collet housing 7, as may be seen in FIGS. 1 and 2. The tool 100 is biased in the RIH position buy a spring 6 disposed within the spring housing 4 and around the mandrel 5, which bears on a shoulder formed by the mandrel 5 and a shoulder formed by the spring housing 4. The spring 6 urges the mandrel 5 upwards relative to the spring housing 4. This obviously urges the collet fingers 9 to be in RIH position, away from the indicator buttons 20.

A force which compresses the spring 6 will move the mandrel 5 and collet holder 8 downwards relative to the collet housing 7, to its POOH position, where the bulbous protrusion of the collet fingers 9 distal end 9a are each aligned with an indicator button 20. When the collet fingers 9 are at their maximum OD, which matches the nominal ID of the tubular through which the tool passes, each indicator button 20 is in its original, undisplaced position.

In one embodiment, at least three fingers 9 and corresponding buttons 12 are arrayed around the circumference of the tool 100. Preferably, there are four to eight finger and button combinations. A six finger 9 configuration is shown in the Figures. A greater number of finger and button combinations provides greater resolution for determining a deformation in the tubular.

As may be seen in FIG. 1B, in the POOH position, each collet finger 9 is positioned over an indicator button 20, and when the collect finger 9 is flexed inward, such as when the tool 100 passes through a reduced diameter restriction in a tubular, the button 12 is moved inwards. The degree of displacement of the button 12 is indicative of the inside diameter (ID) of a restriction through which the tool 100 has passed. In some embodiments, the indicator button may comprise a visual indicator of degree of displacement. For example, the wall of the housing opening in which the button is installed may include markings, such as colours, numbers or symbols, which become visible by displacement of the button. The markings may be the ratchet teeth or threads. For example, each ratchet thread may be indicative of 1/16″ (0.0625″) of casing ID deformation.

The fingers 9 are sufficiently flexible to bend inwards when the tool 100 passes through a deformation or restriction, but sufficiently rigid to not bend under the forces encountered during normal operation. In one embodiment, an inward radial force between about 100 lbs to about 350 lbs is required to bend a single finger 9 to contact and displace the indicator button 20. One skilled in the art will be able to design suitable collet fingers having regard to their length and material. Preferably, the fingers are robustly designed and manufactured to be more resistant to breakage and wear and tear, reducing the likelihood of a finger breaking and being lost in hole.

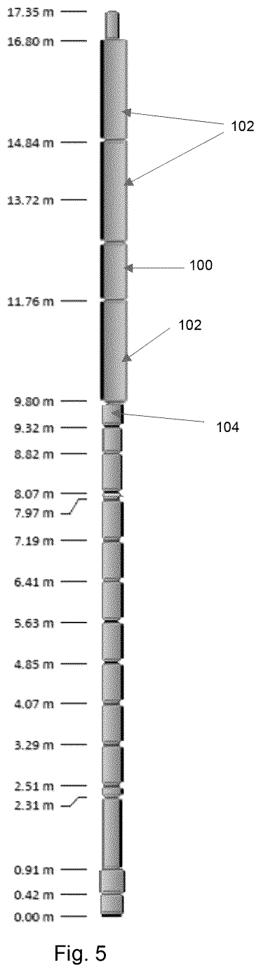

In use, the tool 100 is placed as part of a bottom hole assembly (BHA) configured for a wellbore operation, such as for a wireline plug and perf operation. As shown in FIG. 5, the tool 100 is placed over the wireline in a suitable location, with weight bars 102 strategically placed above and below the tool 100. The wireline (not shown) passes through the weight bars 102 and tool 100 to connect to a cable head positioned within a swallow sub 104. Below the swallow sub 104 are conventional wireline BHA components including perforating guns.

When the tool is in its POOH position and pulled through a tubular having a deformation which reduces the radius R of the tubular in any orientation, a collet finger 9 which contacts that deformation will be flexed inwardly thereby displacing the corresponding indicator button 20. Upon retrieval to the surface, the tool may be examined to determine which, if any, indicator buttons 20 have been displaced, and the degree of displacement. However, this examination cannot provide information about the location of the deformation in the tubular string through which the tool 100 has been pulled. In one embodiment, in order to provide location information, pull tension is measured and logged over the time the tool 100 has been pulled. The time at which pull tension increases indicates a high friction event which can be correlated to the indicator button displacement.

In some embodiments, the cable head swallow sub 104 includes an inline-tension meter (not shown) which measures the tension force within the wireline. In effect, this tool measures resistance of the BHA to the pulling force of the wireline. In addition, the surface wireline equipment (not shown) can include a tension measuring meter which measures the pulling force of the equipment on the downhole wireline. One or both of these tension meters can be combined with deformation detection with the tool to localize a deformation detected by the tool.

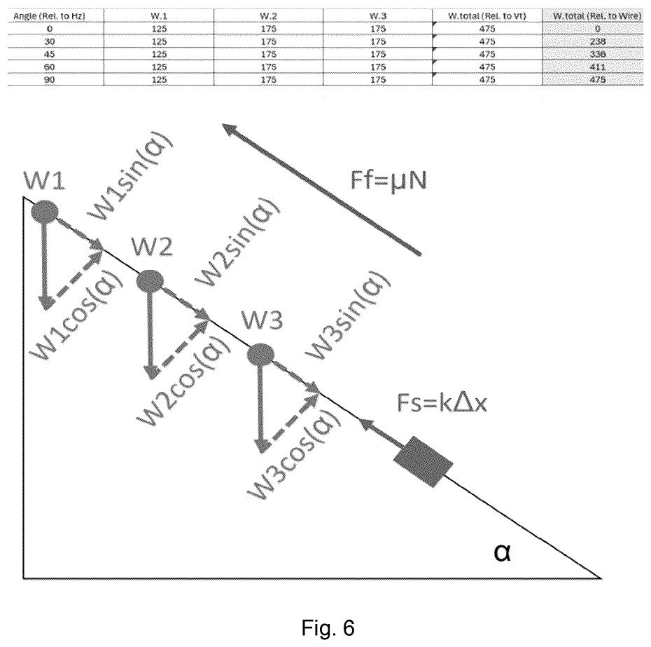

In one aspect, disclosed is a BHA which is configured to detect and localize a deformation in a tubular, and in particular, a tubular in a build section or vertical section of a wellbore which includes a horizontal section. In one embodiment, the BHA includes at least one weight bar 102 positioned above the tool 100, such that the weight bar bears on the tool when the BHA is positioned vertically or on an incline. The weight which bears on the tool must overcome the spring strength in order to move the tool into its POOH position, where the collet fingers 9 are positioned over the indicator buttons 20. When the BHA is vertical, if the weight of the weight bars exceeds the spring strength, then this shift will be actuated. When the BHA is inclined when in the build or transition section, the wireline component of the force vectors can be calculated, as is schematically illustrated in FIG. 6. In FIG. 6, an example is illustrated where the BHA is inclined at angle a and there are three weight bars W1, W2, and W3. The force component acting along the wireline may be calculated. Thus, in a preferred embodiment, the BHA can be configured to move the tool into its POOH position while the BHA is being pulled out in the build section of the wellbore.

In one aspect, disclosed is a method of detecting a deformation in a downhole tubular, comprising the steps of:
(a) pulling a tool through tubular while sensing and logging a pull tension indicative of friction between the tool and an inside surface of the tubular, wherein the tool comprises a plurality of indicator buttons, each button moveable between a start position and an inwardly depressed indicator position, wherein the button is displaced by the deformation; and
(b) retrieving the tool and determining a correlating a pull tension event with a displacement of at least one indicator button to determine a location and size of the deformation.

In preferred embodiments, the tool comprises a mechanical deformation detection tool as described herein.

Thus, a tension measuring device may be used in conjunction with a deformation detection tool, such as the tool described above, to determine the location of any deformations in the casing and the degree of deformation. The tool 100 itself is purely mechanical and does not contain any electronics to measure or store data. The physical displacement of the buttons indicates the degree of deformation or restriction that the tool 100 has passed through on its passage through the tubular or casing. It does not provide any information as to where the deformation is located. The location may be determined by reviewing the tension data of one or both of the surface and downhole tension meters. When the tool 100 passes through a deformation or restriction, the contact friction with the casing wall momentarily increases the tension in the wireline. These tension events may be detected and logged by one or both of the tension meters and correlated to the displacement of the buttons 20 measured at the surface once the tool 100 is retrieved. This correlation provides information regarding the depth of the deformation and the magnitude of the deformation.

In addition, the pull tension may be greater in the case of a larger deformation as compared to a smaller deformation. This may correlate to a greater number of indicator buttons being displaced, and/or a greater degree of displacement for at least one indicator button.

If the tension meters record two significant tension events, and the buttons indicate a total displacement of ⅛″, it may indicate that two restrictions exist, the first (downhole) restriction being about 1/16″ and the second (uphole) being about ⅛″. If only a single significant tension event is recorded, that will indicate that the tool 100 passed through a deformation or restriction, and did not subsequently pass through another deformation or restriction with a smaller ID. It may have subsequently passed through a lesser deformation.

In addition, a greater number of buttons arrayed around the tool provides greater resolution in determining the nature of the deformation, as patterns of button displacement are indicative of the shape of the deformation. For example, if buttons on opposing sides of the tool are displaced while others are not, that can be indicative of the tubular being oval in shape at one location.

Interpretation.

The forgoing description supplies specific details in order to provide a thorough understanding. Nevertheless, the skilled artisan would understand that the apparatuses, systems, and associated methods of using the apparatuses and systems can be implemented and used without employing these specific details. Indeed, the apparatuses, systems, and associated methods can be placed into practice by modifying the illustrated apparatus and associated methods and can be used in conjunction with any other apparatus and techniques conventionally used in the industry.

The corresponding structures, materials, acts, and equivalents of all means or steps plus function elements in the claims appended to this specification are intended to include any structure, material, or act for performing the function in combination with other claimed elements as specifically claimed.

References in the specification to “one embodiment”, “an embodiment”, etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such module, aspect, feature, structure, or characteristic with other embodiments, whether or not explicitly described. In other words, any module, element or feature may be combined with any other element or feature in different embodiments, unless there is an obvious or inherent incompatibility, or it is specifically excluded.

It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition or step being referred to is an optional (not required) feature of the invention.

The singular forms “a,” “an,” and “the” include the plural reference unless the context clearly dictates otherwise. The term “and/or” means any one of the items, any combination of the items, or all of the items with which this term is associated. The phrase “one or more” is readily understood by one of skill in the art, particularly when read in context of its usage.

As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio.

1. A mechanical casing deformation detection tool having a central longitudinal axis, comprising:
(a) a housing assembly comprising top and bottom connections to form part of a bottom hole assembly and a collet housing defining a plurality of longitudinal slot openings;
(b) a plurality of external indicator buttons mounted in the collet housing, each moveable radially inwards from a start position;
(c) a mandrel disposed within the housing assembly, the mandrel moveable between a run-in-hole (RIH) position and a pull-out-of-hole (POOH) position; and
(c) a plurality of flexible collet fingers affixed to the mandrel and each comprising a distal end extending radially outwards through a slot opening and downwards such that the distal end is positioned over an indicator button when the mandrel is in its POOH position, wherein the distal end is radially moveable between a start position and an indicator position which bears inwardly on an indicator button.

2. The tool of claim 1, wherein each indicator button is biased radially outward and comprises ratchet teeth which permit inward displacement but not outward movement of the indicator button within the collet housing.

3. The tool of claim 1 wherein each collet finger may be moved radially inward to bear on an indicator button by a force between about 100 lbs and lbs.

4. The tool of claim 1, wherein there are 3 or more collet fingers arrayed radially around the mandrel.

5. The tool of claim 4, wherein there are between 6 to 8 collet fingers.

6. The tool of claim 1 comprising an indicator of a degree of displacement of an indicator button.

7. The tool of claim 6 wherein the indicator comprises a number of ratchet teeth or threads.

8. A bottom hole assembly (BHA), comprising a tool as claimed claim 1.

9. The bottom hole assembly of claim 8, comprising at least one weight bar positioned above the tool, wherein the at least one weight bar bears upon the tool when the BHA is positioned vertically or inclined.

10. The bottom hole assembly of claim 9 wherein the at least one weight bar is sized to exert sufficient force to move the tool to its POOH position when the BHA is inclined or vertical.

11. The bottom hole assembly of claim 10 wherein the at least one weight bar is sized to overcome a spring biasing the tool into its RIH position, when the BHA is inclined or vertical.

12. A method of detecting a deformation in a downhole tubular, comprising the steps of:
(a) pulling a tool through the tubular while sensing and logging a pull tension indicative of friction between the tool and an inside surface of the tubular, wherein the tool comprises a plurality of indicator buttons, each button moveable between a start position and an inwardly depressed indicator position, wherein the button is displaced by the deformation; and
(b) retrieving the tool and determining a correlation between a pull tension event with a displacement of at least one indicator button to determine a location of the deformation.

13. The method of claim 12, wherein the indicator button comprises an indicator of degree of displacement, and method comprises the step of determining the size of the deformation.

14. The method of claim 12 wherein the tool is a tool as claimed in claim 1.

15. The method of claim 14, wherein the pull tension is sensed and logged by either one or both of a tension meter within a BHA comprising the tool and a surface tension meter.
